(19) United States
(12) Patent Application Publication
(10) Pub. No.: US 2002/0063176 A1
(43) Pub. Date: May 30, 2002

(54) Device and method for the electrostatic atomization of a liquid medium

(76) Inventors: Uwe Leuteritz, Regensburg (DE); Bruno Schuermans, Baden (CH); Christian Steinbach, Neuenhof (CH); Wolfgang Weisenstein, Remetschwil (CH)

Correspondence Address: BURNS DOANE SWECKER & MATHIS L L P, POST OFFICE BOX 1404, ALEXANDRIA, VA, 22313-1404, US

(21) Appl. No.: 09/970,776

(22) Filed: Oct. 5, 2001

(30) Foreign Application Priority Data
Oct. 5, 2000 (DE) 100 49 204.5

(51) Int. Cl. B05B 5/00; F23D 11/32

(52) U.S. Cl. 239/696; 239/706; 239/690

(57) ABSTRACT

A device and method for atomizing a liquid medium, including an electrically conductive nozzle body with an internal volume for holding the liquid medium, at least one nozzle opening as well as a high-voltage electrode arranged inside the internal volume coaxially to a longitudinal axis of the nozzle body. The high-voltage electrode is provided in the area of its greatest lateral expansion with a circumferential, sharp edge that extends at a small distance to the nozzle body in order to be able to bring about the electrostatic charging of the passing liquid medium. This construction enables the electrostatic atomization in a simple manner even for multi-hole nozzles, so that the electrostatic atomization also can be used in the field of gas turbine technology for improving the injection in the start-up and partial load range.

### TECHNICAL FIELD OF APPLICATION

The invention at hand relates to a device as well as a method for the electrostatic atomization of a liquid medium, whereby the device comprises an electrically conductive nozzle body with an internal volume for holding the liquid medium, at least one nozzle opening for the discharge of the liquid medium, as well as a high voltage electrode arranged coaxially to a longitudinal axis of the nozzle body with the internal volume, with which high voltage electrode passing liquid medium is electrostatically charged immediately before its discharge from the nozzle opening.

The device and associated method are used in particular in turbo machines, such as gas or steam turbine systems, for injecting or nozzling in the liquid fuel.

### STATE OF THE ART

Often, pressurized atomizers in which the liquid medium is fed under high pressure to the internal volume of a nozzle body and is atomized through the nozzle opening into fine drops during the following expansion are used for atomizing a liquid medium, such as, for example, a liquid fuel. In order to support this atomization, it is known to additionally charge the liquid medium electrostatically via a high voltage electrode before it is discharged from the nozzle. Because of the repulsive forces of the charges, this electrostatic charge achieves a better and finer atomization.

DE 41 06 564 A1, for example, discloses a device for the electrostatic atomization of liquids, in particular of fuel, that comprises an atomizer nozzle. The nozzle consists of an electrically conductive nozzle body that is on ground potential and is provided with a nozzle opening for discharging a pressurized fluid volume. In the internal volume of the nozzle body is arranged an electrode coaxially opposite from the nozzle body, which electrode is on a high voltage potential. The electrode has a conical tip positioned directly at the outlet opening of the nozzle body that is shaped like a truncated cone. Through the very high electrical fields on this conical tip of the electrode, the passing fluid is electrostatically charged directly before the discharge from the nozzle opening. Because of this electrostatic charging, the fluid is atomized into a very fine spray fog after being discharged from the nozzle opening. A similar device is found in DE 41 06 563 A1.

U.S. Pat. No. 4,051,826 discloses a device for fuel injection into a cylinder space of a combustion machine. The nozzle used for this has several nozzle openings whose limits are designed as sharp edges. In this device, the casing receives a high voltage potential, so that very high electrical fields that also result in an electrostatic charging of the exiting fluid are present at the outlet openings. Because there is no high potential differential at these outlet openings, the level of the electrostatic charge is however only small.

Especially in the preferred field of application of the invention at hand, the quality of atomization of the liquid fuels used plays a significant role in the stability of the combustion, the efficiency as well as the noxious emissions generated. In gas turbine burners with lean premixing, frequently multi-hole pressure nozzles are used hereby in order to achieve a good distribution of the fuel in the combustion air.

The disadvantage of such multi-hole pressure nozzles—as of single-hole pressure nozzles—is that the atomization quality depends on the pressure of the liquid medium or fuel oil to be atomized, and therefore on the oil throughput. In gas turbines with pressure nozzles, this fact has an especially negative effect on the starting and partial load behavior, since the oil throughputs are small under these conditions. This can be recognized in FIG. 1, which shows the relative fuel mass flow (m_brennstoff) [m_fuel] or fuel pressure (p_brennstoff) [p_fuel] in relation to the gas turbine power. Especially at a low pressure level, the atomization quality of standard pressure nozzles is hereby less then desirable.

In the past, the fuel in such gas turbine fuel systems was therefore usually supplied in different nozzle stages. A pilot stage covers the start and lower partial load range. The further main stage is provided for operating the upper partial load range as well as the full load. However, both stages require separate fuel supply and control systems so that the expenditure for providing such a fuel system is relatively high.

Although electrostatic single-hole nozzles that improve the atomization quality are known from the above mentioned state of the art, these nozzle constructions cannot be simply transferred to multi-hole nozzles. For example, a corresponding electrode with a conical tip positioned exactly above the corresponding nozzle opening would have to be provided for each nozzle opening. But this increases the expenditure in the manufacturing of the nozzles and leads to reliability problems due to thermal deformation in the face of the very high temperatures that occur in particular in the combustors of gas and steam turbines.

The construction of a multi-hole nozzle disclosed by the second publication, on the other hand, did not achieve a satisfactory electrostatic charging of the liquid medium with justifiable high voltage values.

### DESCRIPTION OF THE INVENTION

The present invention is therefore based on the objective of making available a device and a method for the electrostatic atomization of a liquid medium that are able, in particular, to enable the use of a multi-hole pressure nozzle and providing an adequate atomization quality even during the start-up and with a partial load of a turbo machine.

The objective is realized with the device and the method according to claim 1 and, respectively, claim 8. Advantageous embodiments of the device and associated method are the subject of the secondary claims.

The device according to the invention for atomizing a liquid medium consists of an electrically conductive nozzle body that comprises an internal volume for holding the liquid medium, at least one nozzle opening for the discharge of the liquid medium, as well as a high voltage electrode arranged in the internal volume coaxially to a longitudinal axis of the nozzle body. The high voltage electrode is arranged in such a way that it is able, on applying a high voltage, to electrostatically charge passing liquid medium immediately before its discharge from the nozzle opening or nozzle openings in such a way that the atomization quality is improved as a result of this electrostatic charge. Naturally, the electrically conductive nozzle body is put on ground potential for this purpose in order to generate an adequately sized electrical field between the high voltage electrode and nozzle body in the area of the nozzle opening. According to the invention, the high-voltage electrode is provided with a circumferential sharp edge in the area of its greatest lateral expansion-in a plane essentially vertical to the longitudinal axis of the nozzle body-which extends at a small distance to the nozzle body in order to be able to bring about the electrostatic charging of the passing liquid medium. A sharp edge hereby should be understood to mean in any case an acute edge angle, i.e., an edge angle of less than 90°. The sharp edge hereby naturally also may have a zigzagged shape with tips.

Naturally, this edge must extend immediately next to the nozzle opening(s) in order to be able to bring about the desired electrostatic charging of the liquid medium directly before its discharge from the nozzle opening.

The device preferably is a multi-hole nozzle whose nozzle openings are located in or close to the plane in which the sharp edge of the high-voltage electrode extends. It is hereby also possible to provide several rows of nozzle openings that are spaced apart from each other in the longitudinal direction of the nozzle body, in which case a separate circumferential sharp edge is constructed on the high-voltage electrode for each row.

In addition, a central outlet opening can be constructed on the longitudinal axis of the nozzle body. An electrical field is applied to such a central nozzle opening in this area by an additional tip on the high-voltage electrode, as is known from the state of the art for single-hole nozzles.

The nozzle body is preferably constructed rotation-symmetrical around its longitudinal axis and has a tapered shape in the area of the nozzle openings, for example, in the shape of a truncated cone. With a rotation-symmetrical design of the nozzle body or internal volume, the present high-voltage electrode is preferably constructed approximately in the shape of a plate. Such a design easily can be technically realized and is unsusceptible to thermal deformation.

During operation of the device according to the invention, the liquid medium is fed pressurized into the internal volume, the nozzle body is put on ground potential, and a high voltage is applied to the high-voltage electrode, which brings about an electrostatic charging of the liquid medium in a magnitude that, because of the additional electrostatic charging, results in a bursting of the drops discharged from the nozzle opening(s).

In a special embodiment of the operating method of this atomization device, a pulsed high voltage with variable duty cycle (duration of high voltage/period duration) and/or variable high voltage is applied to the high-voltage electrode, whereby the atomization quality is specifically influenced by changing the duty cycle of the high voltage. A targeted modulation of the high voltage and/or duty cycle rate with a certain pulse frequency also would be conceivable. Such an influencing is especially advantageous for dampening combustion instabilities during the operation of a gas or steam turbine system, whereby the lower fuel pressure in start-up or partial load operation increases the duty cycle, and the duty cycle is reduced during a stronger partial load or full load operation. This measure makes it possible to achieve an approximately constant atomization quality over the entire operating range, since the high pressure in full load operation already results in a high atomization quality even without electrostatic atomization, while in the case of a lower pressure during start-up or lower partial load operation the low atomization quality is increased by the additional electrostatic atomization.

A change of the atomization in the partial load operation also can be influenced by changing the high voltage, for example by increasing it from 10 kV to >20 kV.

The present invention and associated method are therefore characterized by a simple construction that in particular also enables the principle of electrostatic atomization for multi-hole pressure nozzles. The construction of the device with the circumferential sharp edge is substantially less susceptible to thermal deformation than a construction with conical tips provided separately for each nozzle opening.

### BRIEF DESCRIPTION OF DRAWINGS

The device according to the invention is described briefly again below in reference to the figures without limiting the general idea of the invention. Hereby:

FIG. 1 shows an example of the relative fuel mass flow and pressure in relation to the power of a gas turbine;

FIG. 2 schematically show the construction of a first embodiment of the device according to the invention;

FIG. 2a schematically shows the construction of a second embodiment of the device according to the invention;

FIG. 3 schematically shows a principle drawing of the electrostatic atomization;

FIG. 4 shows examples for the effect of using the present device on atomization quality; and,

FIG. 5 shows the view of a high-voltage electrode with zigzagged extension of the sharp edge according to the view V-V in FIG. 2.

### WAYS OF EXECUTING THE INVENTION

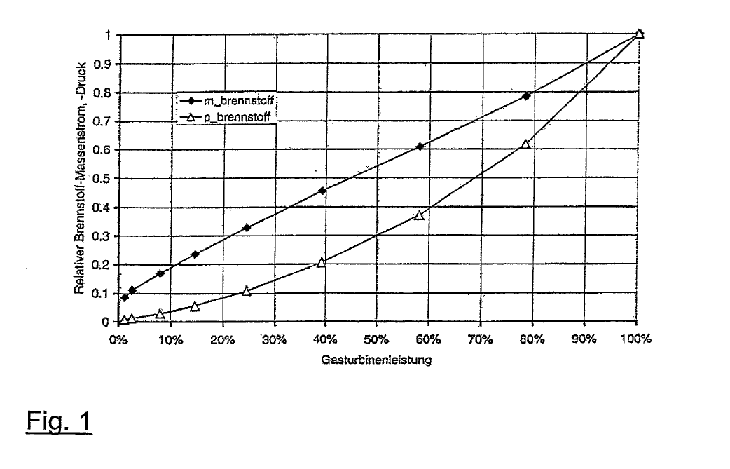

FIG. 1 shows an example of how the fuel pressure during the operation of a gas turbine depends on the gas turbine performance. The figure clearly shows that in the case of low gas turbine performance during start-up or partial load operation a clearly lower fuel pressure exists than in the case of a higher gas turbine performance or full load operation. The figure hereby shows the values for the relative fuel mass flow (m_brennstoff) [m_fuel] and fuel pressure (p_brennstoff) [p_fuel] in relation to the gas turbine performance. Based on the shown relationship it can be seen that the pressure in the atomization nozzle may assume very different values depending on the operating state of the gas turbine, so that the atomization quality of the pressure atomization is not satisfactory, especially for a lower gas turbine performance.

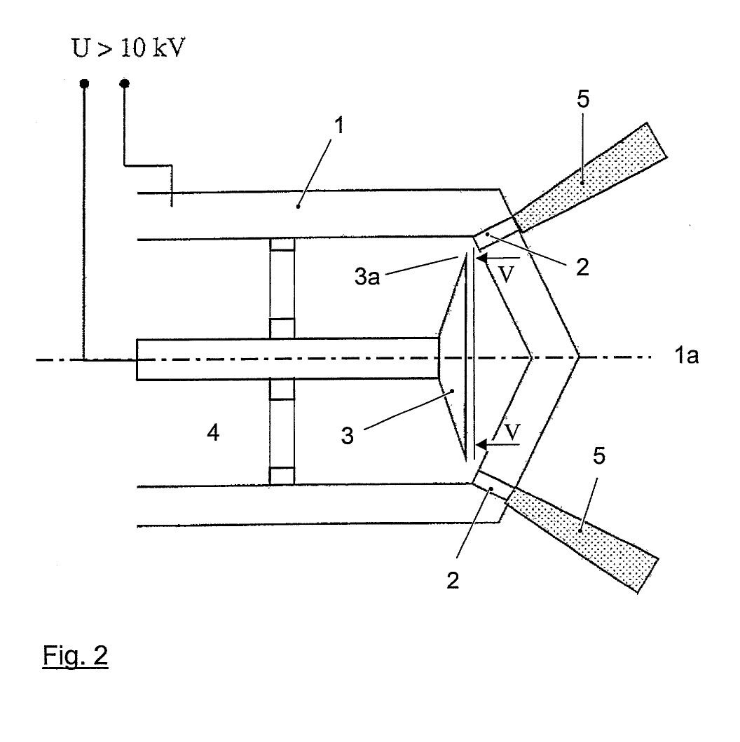

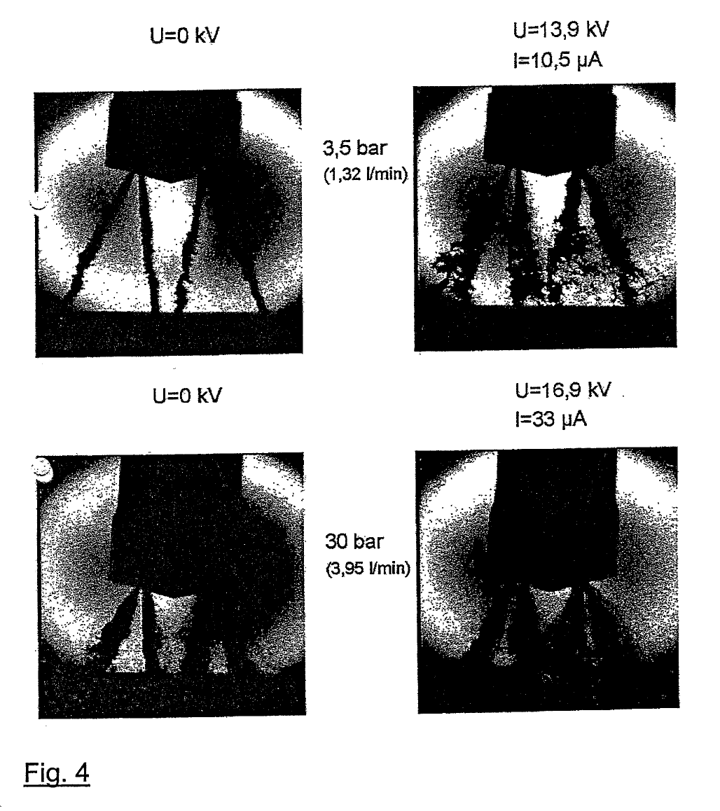

FIG. 2 shows an example of an atomization device or atomizer nozzle according to the invention that can be used to clearly improve the atomization quality, especially in the start-up or partial load operation of a gas turbine. The figure shows the frontal part of the electrically conductive nozzle body 1 that encloses the internal volume 4 holding the liquid medium, for example, a fuel oil or another non-conductive atomization medium. In this example, the nozzle body is constructed rotation-symmetrical around its longitudinal axis 1a. In the frontal part, nozzle openings 2 for discharging the liquid medium are provided. The discharged, electrostatically atomized spray 5 is hereby indicated schematically. In the internal volume 4, a high-voltage electrode 3 is located in order to electrostatically charge the passing liquid medium directly before its discharge from nozzle openings 2. The high-voltage electrode 3 is constructed in a plate shape and has in the area of its greatest expansion a circumferential, sharp edge 3a. The plane in which this sharp edge 3a extends essentially corresponds to the plane in which the nozzle openings 2 are arranged distributed on the nozzle body 1. A sharp edge 3a hereby should always be understood as an acute edge angle, i.e., an edge angle of less than 90°. As can be seen in FIG. 5 that shows the view according to line V-V in FIG. 2, the sharp edge 3a hereby naturally also may have a zigzagged course with tips.

Naturally, this edge 3a must extend directly next to the nozzle opening(s) 2 in order to be able to bring about the desired electrostatic charging of the liquid medium immediately prior to its discharge from the nozzle opening.

According to FIG. 2a, a central nozzle opening 2a also may be provided on the longitudinal axis la of the nozzle body 1. Such a central nozzle opening 2a is supplied with an electrical field in this area via an additional tip 3b on the high-voltage electrode 3, as is known from the state of the art in single-hole nozzles.

If a high voltage is applied to this high-voltage electrode 3, an electrical field with especially high field intensity forms at the sharp edge 3a. This high field intensity enables the discharge of electrons from the electrode, and therefore a charging of the oil flowing around the electrode. The proximity of the sharp edge 3a to the nozzle body 1 that is on ground potential and to the nozzle openings 2 causes the fuel oil to be electrostatically charged immediately prior to its discharge from the nozzle openings, so that it is able to essentially maintain this electrostatic charge when being discharged from the nozzle.

The distance of the sharp edge 3a from the nozzle body 1 naturally must be selected in such a way in relation to the applied high voltage and electrical properties of the liquid medium used that no electrical break-down to the nozzle body 1 takes place. On the other hand, this sharp edge 3a must be positioned as close as possible to the nozzle body 1 in order to be able to achieve the desired size of the electrical field. As a rule, a high voltage U>10 kV and a distance in the magnitude of 1 mm between the sharp edge 3a and the nozzle body 1 will be selected when using such a multi-hole nozzle in burners of gas turbines.

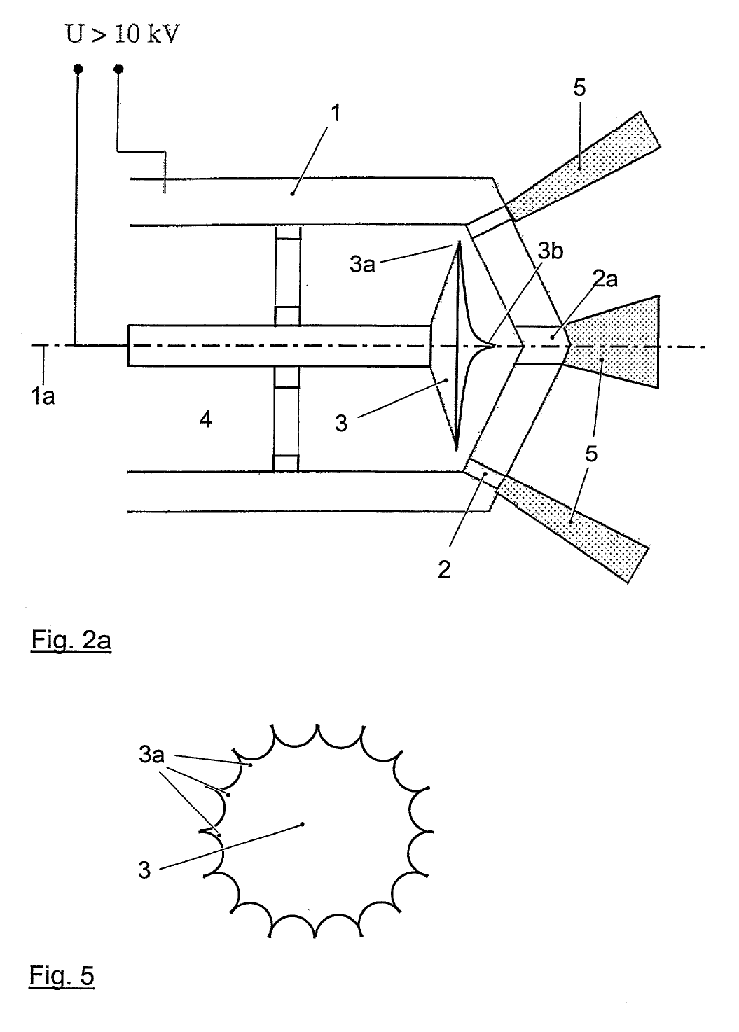

FIG. 3 shows the action principle of the electrostatic charge during the electrostatic atomization. Hereby a drop 6 not electrostatically charged is shown schematically on the left; in this drop, only the surface tension forces F₁ that hold the drop together are active (indicated by arrows). The homopolar charging of the oil during its passage through the nozzle according to the invention electrostatic forces Fₑ₁ that repel each other act within the fluid elements. If, after the discharge from the nozzle, these forces are greater than the surface tension forces F₁ that hold the drop together, the drop will burst. The right side of FIG. 3 hereby shows the additionally acting electrostatic forces Fₑ₁ in an electrostatically charged drop 7. The drop 7 will burst until the charging forces within the drop are smaller than the surface tension forces and the drop is therefore stable.

The suggested technique also makes it possible to achieve sufficient atomization qualities at a lower pressure. This means the throughput of the liquid medium and the atomization or atomization quality are no longer dependent on each other.

In a special embodiment of the operating method of this atomization device, the high-voltage electrode 3 is supplied with a pulsed high voltage with variable duty cycle (duration of high voltage/period duration) and/or variable high voltage, whereby the atomization quality is influenced in a targeted manner by changing the duty cycle of the high voltage. A targeted modulation of the high voltage and/or duty cycle rate with a specific pulse rate is also conceivable. Such an influencing is especially advantageous for dampening combustion instabilities during the operation of a gas or steam turbine system, whereby the lower fuel pressure in start-up or partial load operation increases the duty cycle, and the duty cycle is reduced during a stronger partial load or full load operation. This measure makes it possible to achieve an approximately constant atomization quality over the entire operating range, since the high pressure in full load operation already results in a high atomization quality, even without electrostatic atomization, while in the case of a lower pressure during start-up or lower partial load operation, the low atomization quality is increased by the additional electrostatic atomization.

A change of the atomization in the partial load operation also can be influenced by changing the high voltage, for example, by increasing it from 10 kV to >20 kV.

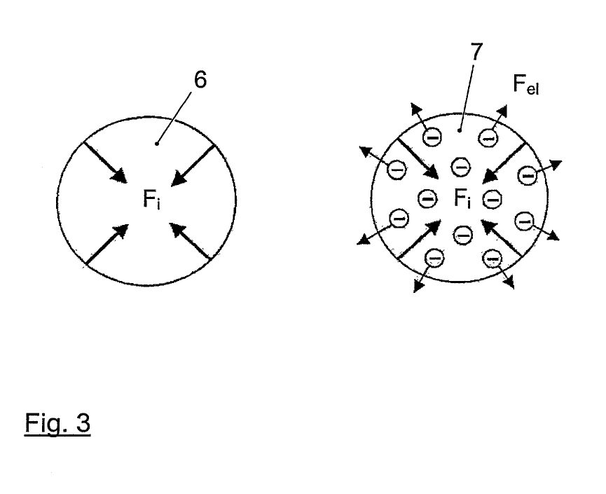

FIG. 4 shows shadow images of fuel nozzles according to the invention with and without high voltage applied for different fuel throughput. In all four images, the nozzle body from which four fuel jets are discharged via the discharge openings can be seen on the top.

The left part of the figure shows the operation of the device without any high voltage applied, i.e., as a standard multi-hole pressure nozzle. While at a high fuel throughput of 3.95 l/min according to a pressure in the nozzle of 30*10⁵ Pa (30 bar) an adequate atomization can be seen (lower part of figure), it is hardly possible to achieve an atomization of the fuel with a lower fuel throughput of only 1.32 l/min according to a pressure of 3.5*10⁵ Pa (3.5 bar).

By applying a corresponding high voltage of 13.9 kV in the top part and 16.9 kV in the lower part of the figure, a clearly improved atomization can be achieved, as can be seen from the comparison with the respective opposing figures for the same fuel throughput. Especially with a low fuel throughput, the present device is able to achieve a clear improvement of the atomization quality, as can be seen in FIG. 4.

The present device and the associated method therefore are characterized by a simple construction, which in particular enables the principle of electrostatic atomization even in multi-hole pressure nozzles. The construction of the device with the circumferential sharp edge 3a is significantly less susceptible to thermal deformation than a construction with conical tips provided separately for each nozzle opening.

### LIST OF REFERENCE NUMBERS

1 Nozzle body

1a Longitudinal axis

2 Nozzle opening

2a Nozzle opening, central

3 High-voltage electrode

3a Sharp edge

3b Tip

4 Internal volume

5 Electrostatically atomized spray

6 Drop not electrostatically charged

7 Electrostatically charged drop

1. Device for atomizing a liquid medium, consisting of
an electrically conductive nozzle body (1) provided with an internal volume (4) for holding the liquid medium,
at least one nozzle opening (2) for discharging the liquid medium, as well as
a high-voltage electrode (3) arranged inside the internal volume (4) coaxially to the longitudinal axis (1a) of the nozzle body (1) in order to electrostatically charge passing liquid medium directly before the discharge from the nozzle opening (2),
characterized in that
the high-voltage electrode (3) is provided in the area of its greatest lateral expansion with a circumferential sharp edge (3a) that extends at a small distance to the nozzle body (1) in order to bring about the electrostatic charging of the passing liquid medium.

2. Device as claimed in claim 1,
characterized in that
several nozzle openings (2) are provided for the discharge of the liquid medium.

3. Device as claimed in claim 2,
characterized in that
the nozzle openings (2) are arranged distributed in a plane across the circumference of the nozzle body, in or near which plane the sharp edge (3a) of the high-voltage electrode (3) extends.

4. Device as claimed in claim 3,
characterized in that
at least one additional nozzle opening (2a) is arranged on the longitudinal axis (1a) of the nozzle body (1), whereby the high-voltage electrode (3) forms a tip (3b) in this area.

5. Device as claimed in one of claims 1 to 4,
characterized in that
the nozzle body (1) has a tapering shape in the area of the nozzle openings (2).

6. Device as claimed in one of claims 1 to 5,
characterized in that
the high-voltage electrode (3) is constructed essentially in a plate shape.

7. Device as claimed in one of claims 1 to 6,
characterized in that
the circumferential sharp edge (3a) of the high-voltage electrode (3) has a zigzagged extension with tips.

8. Method for atomizing a liquid medium using a device as claimed in one of claims 1 to 7, wherein
the liquid medium is supplied to the internal volume (4) of the device under pressure, the nozzle body (1) is put on ground potential, and a high voltage is applied to the high-voltage electrode (3), said high voltage bringing about an electrostatic charging of the liquid medium in a magnitude that results in the bursting of the drops discharged from the nozzle opening(s) due to the electrostatic charge.

9. Method as claimed in claim 8,
characterized in that
a pulsed high voltage with variable duty cycle and/or variable high voltage is applied to the high-voltage electrode (3), whereby the atomization quality is influenced by changing the duty cycle of the high voltage.

10. Method as claimed in claim 9,
characterized in that
the duty cycle is increased with a reduction of the pressure of the liquid medium, and is reduced when the pressure of the liquid medium is increased.

11. Method as claimed in claim 9 for atomizing liquid fuel in the combustor of a gas turbine,
characterized in that
during the start-up or partial load operation of the gas turbine, a higher duty cycle is set than during full load operation of the gas turbine.

12. Method as claimed in claim 8 for atomizing liquid fuel in the combustor of a gas turbine,
characterized in that
the atomization quality during the partial load operation of the gas turbine is influenced by changing the high voltage.
